(19) United States
(12) Patent Application Publication
(10) Pub. No.: US 2014/0198330 A1
(43) Pub. Date: Jul. 17, 2014

(54) PORTABLE SYSTEM PERFORMING BUSINESS CENTER OPERATIONS

(71) Applicant: XEROX CORPORATION, Norwalk, CT (US)

(72) Inventors: Rinku Gajera, Bengaluru (IN); Nischal M. Piratla, Hyderabad (IN); Atul K. Saraf, Bangalore (KA) (IN); Vidhi Goel, Haryana (IN); Abhinav Dapke, Bangalore (IN); Girish Prabhu, Bangalore (IN)

(73) Assignee: Xerox Corporation, Norwalk, CT (US)

(21) Appl. No.: 13/742,438

(22) Filed: Jan. 16, 2013

(51) Int. Cl. H04N 1/00

(52) U.S. Cl. CPC H04N 1/00519
USPC 358/1.13

(57) ABSTRACT

The present disclosure describes a portable system for performing business operations. The portable system includes a multi-function device (MFD) including a surface for keeping stationery items, the surface have multiple curved edges for accommodating space constraints, a customizable partition for providing visual privacy to at least one of an official and multiple customers while filling multiple forms and branding, a perforated pattern across at least three sides of the MFD for providing ventilation, a cable management unit for connecting the MFD with a power source, one or more storage units for storing promotional material, a number of filled forms, a product manual, and one or more maintenance records, and a printout interface for providing a point of interaction for customers in order to access one or more printouts. The portable system also includes a user interface for allowing an official or customers to interact with the MFD.

### TECHNICAL FIELD

The presently disclosed subject matter relates to business services and operations, and more particularly, to a portable system usable as an operations center for facilitating certain types of business transactions.

### BACKGROUND

Individuals typically spend a significant amount of time dealing with a variety of banking, telecom and/or postal related tasks. To use any one of these services, customers typically interact with a physical branch or location. With the advent of the Internet, many of these activities can now be performed online. For instance, bank customers can perform routine transactions, such as transferring funds, applying for loans, and viewing an account summary, through online banking. In remote or rural areas, however, persons may not be widely aware of online services, and thus online services tend to be underused. Even if people in the rural areas know how to use online services, network connectivity remains an impediment to its widespread adoption. Thus, these customers must visit a nearby bank branch or telecom center for certain specific services. For example, an individual may visit a nearby branch and complete an application form for opening a new account, applying for loans, changing contact information, or similar services. This process often requires, submitting one or more documents, such as proof of address and/or identity. The completed application forms and the other related documents are then sent to a back office or processing center. Then, one or more officials from the processing center performs a manual check of each of the documents. If all the information is in order, then a the official scans the documents and manually updates the information into the bank's system; thereby, enhancing redundancy. Subsequently, the bank official or a third party verifies the submitted information. For example, the third party may visit the residence of the customer to verify the identity of the customer and the submitted documents. This process requires significant manual effort, and thus, unnecessarily increases processing time. Moreover, processing time can run into weeks or months for remote locations. If the information in the documents is incomplete or not in order, then the documents are would have to be returned back to branch office and the whole process would have to berepeated.

Branch office hours are often limited and there can be long lines in order to see office personnel. However, even minor tasks can require a visit to the branch. Furthermore, in some industries, hard copies are still required. Moreover, branch office are often unprofitable for their parent company given their high fixed costs and relatively inefficient personnel utilization. Thus, bank branches often are unprofitable while leaving customers unsatisfied. Bank branches in remote areas often connected via satellite links, which experience data losses and other delays.

Users face similar challenges when using services such as telecom services, postal services, and the like. Thus, there is a need to address these continuing challenges associated with various branch office services.

### SUMMARY

The present disclosure describes a portable operations center for use with supplies relevant to business performed at the center. The portable operations center can include an electronic multi-function device (MFD) capable of performing at least one of scanning, photocopying, facsimile transmission and electronic storage. The portable operations center can further include a user interface enabling interaction with and operation of the MFD. The portable operations center can also include a business operations structure that is contiguous with the MFD and the user interface. The business operations structure can be configured to enable portability of the center. The business operations structure can include a surface to facilitate completion of the paperwork, a partition to provide privacy during access to the center, and a storage unit configured to house the supplies.

Some embodiments of the present disclosure also describe a portable system for performing one or more business operations. The portable system includes a multi-function device (MFD), a network interface and a user interface. The MFD can include a surface for keeping one or more stationery items and the surface can include a number of curved edges for accommodating space constraints. The MFD can further include a customizable partition for providing visual privacy to one or more users while they are using the system, for example, while filling out forms. The MFD can further include a perforated pattern across at least three sides of the multi-function device for providing ventilation. The MFD can also include a cable management unit for connecting the MFD with a power source. The MFD can also include one or more storage units for storing various documents and papers, such as promotional materials, filled forms, product manuals and maintenance records. The MFD can also include a printout interface providing a point of interaction for users trying to access one or more printouts. The user interface is coupled to the MFD allowing user interaction. The user interface may also include at least one of a screen and a number of configurable authentication devices. The screen can be a touch sensitive screen. Further, the network interface may be coupled to the MFD and the user interface for providing connectivity and communication between the portable system and one or more remotely located systems including headquarters systems, support systems, back end system, and peer systems.

### BRIEF DESCRIPTION OF THE DRAWINGS

FIG. 1A illustrates an exemplary environment where various embodiments of the present disclosure may be practiced.

FIG. 1B illustrates another exemplary environment where various embodiments of the present disclosure may be practiced.

FIG. 1C illustrates yet another exemplary environment where various embodiments of the present disclosure may be practiced.

FIG. 2 shows a perspective view of a portable system or a portable business center according to an embodiment of the present disclosure.

FIG. 3 illustrates another exemplary embodiment of the portable system according to the present disclosure.

FIG. 4 illustrates another exemplary embodiment of the portable system according to the present disclosure.

FIG. 5 illustrates an exemplary portable system architecture according to another embodiment of the present disclosure.

FIG. 6 illustrates various steps of configuring the portable system of FIGS. 3 and 4.

FIG. 7 illustrates one or more elements of the multi-function device according to an embodiment of the present disclosure.

### DETAILED DESCRIPTION

The following detailed description is made with reference to the figures. Exemplary and in some cases preferred embodiments are described to illustrate the disclosure, not to limit its scope, which is defined by the claims. Those of ordinary skill in the art will recognize a number of equivalent variations in the description that follows.

### DEFINITIONS

In various embodiments of the present disclosure, definitions of one or more terms that will be used in the document are described below. The “portable system” may refer to a device performing various types of operations that are generally performed in a business center, such as a bank branch, a telecom center, a postal office, or the like. The portable system may be capable of receiving an input and displaying an output. Further, the portable system may be scalable based on the type of customers and other requirements.

As used herein, a “Multi-Function Device” (MFD) may be a single device that offers a number of traditionally separate functionalities, such as printing, copying, scanning and faxing. It is envisioned that the MFD can participate in a network with a number of other devices and entities. A “headquarters” device refers to a device at a higher organizational level than an MFD; “peer” devices are on the same general organizational level as an MFD; and “support systems” or “back-office” systems perform support and services operations, such as data entry, verifying documents, or processing transactions, and the like.

### Overview:

The disclosed subject matter describes a low cost branch operation, such as a bank branch, telecom center, postal office, insurance office, educational service facility, or the like. The branch or center is created in the form of a portable system that can perform all typical operations, such as filling application forms, verifying forms, performing business center operations, including uploading or downloading daily reports, requesting stationary and so on. The portable system can also perform most of the operations that are today performed in large bricks and mortar branches. Thus, customers do not need to travel distances and stand in lines in order to perform various tasks. The portable system according to the disclosed embodiments can reduce processing time, processing costs and customer time requirements. Further, the portable system may optimize all document-driven workflows, thereby reducing hard copy usage. Moreover, the portable system can communicate over a network and provide smooth workflow even at slow speeds. The portable system according to the disclosed embodiments can also be easily moved from one area to another area. Further, it may be set up quickly and at a low cost and operated at low cost. Furthermore, the portable system does not require significant human supervision, thus reducing costs operating costs.

The disclosed embodiments refer to the system being portable, which refers to the fact that the system is configured to enable or facilitate movement from one location to another. For example, some embodiments are movable within a single facility, such as between multiple locations within an office building. Other embodiments. Other embodiments are movable between separate buildings, such as between office(s), residences or other buildings. Still other embodiments are movable, but not necessarily ever housed within a building or other permanent structure. For example, some embodiments are functionally and/or structurally connected to a vehicle on a permanent or semi-permanent basis, such as operating within, at or around a truck, bus, airplane or other transport vehicle. Still other embodiments can be movable to, from or between other types of locations, including locations that are outdoors, such as along a street, outside an airport or train station, etc.

Embodiments include any relevant or advantageous configuration(s) to enable or facilitate the above and other types of movements. For example, some embodiments, such as those intended only or primarily to be movable within a single facility, can be configured to be relatively large, more bulky, or otherwise less movable.

Contrarily, other embodiments, such as those intended to not be housed within a building or other permanent or semi-permanent structure, can be configured to be relatively smaller, less bulky, or otherwise more easily movable. In other words, the configurations of the embodiments can be tailored to address the type(s) of intended or anticipated movement.

Embodiments includes any relevant or otherwise advantageous configuration(s) to address issues other than, or in addition to, movability, such as issues of functionality. For example, embodiments having intended or anticipated uses at certain locations can be configured to address issues of functionality of those particular locations. In one such example, a system intended for use in a public or semi-public forum can be configured to enhance functionality in such a setting, such as to include structures to address issues of privacy, etc.

Only a few configurations are disclosed herein for exemplary purposes only, and embodiments are intended to include any configuration and/or structure. For example, some embodiments include a single contiguous or semi-contiguous structure that is movable as a single unit. Some of these embodiments can be structured to facilitate or enhance movement as a single unit, such as configuring element(s) or section(s) of the system to be folded or orientated. Other different embodiments include multiple separable components that can be detached and moved separately.

Embodiments are intended to cover design elements other than different configurations. For example, embodiments are intended to be formed from any material(s) that is advantageous. For example, elements of some embodiments may be formed from certain materials or using certain techniques to enhance resiliency to address intended or anticipated issues relating to functionality, movability, etc. Similarly, elements of some embodiments can be formed from certain materials or by certain techniques to address other issues, such as to provide a reduced cost of manufacture.

Embodiments are also intended to include other types of alternatives. For example, embodiments are intended to cover any known, related art, or later developed technologies, including but not limited to electronics, optics and communications technologies, that are applicable to addressing any of the issued discussed above.

Further, the present disclosure provides design augmentations for a customer facing document services system that provides an efficient user experience. There may be primarily two types of users i.e. service providers (e.g., bank officials) and service seekers (e.g., potential/existing bank customers) that may interact with the portable system. The portable system may be designed for additional functionalities along with visual, tactile, and informational aids for the users while also considering maintenance related tasks and their requirements. Generally, the portable system includes a user interface, a multi-function device, and a network interface. The portable system is capable of managing information in the form of one or more electronic documents. The user interface, multi-function device and the network interface are connected to each other, allowing the portable system to perform the desired task. The user interface allows the user to fill one or more applications forms or further allows the user to access numerous services, such as printing the forms, scanning documents and the like. Moreover, network interface connects the portable system to various back-end offices via a network.

In some embodiments, the portable system may be embodied in the form of a portable banking system. The portable banking system performs a variety of operations that are usually performed in any bank branch and further provides various bank related services to the user. Some examples of services may include, but are not limited to, creating a new account, changing personal information, applying for loans, printing reports, managing profile, viewing customer accounts, viewing branch reports, uploading documents, and downloading documents. Further, the portable banking system automates the process associated with any bank related activity or service.

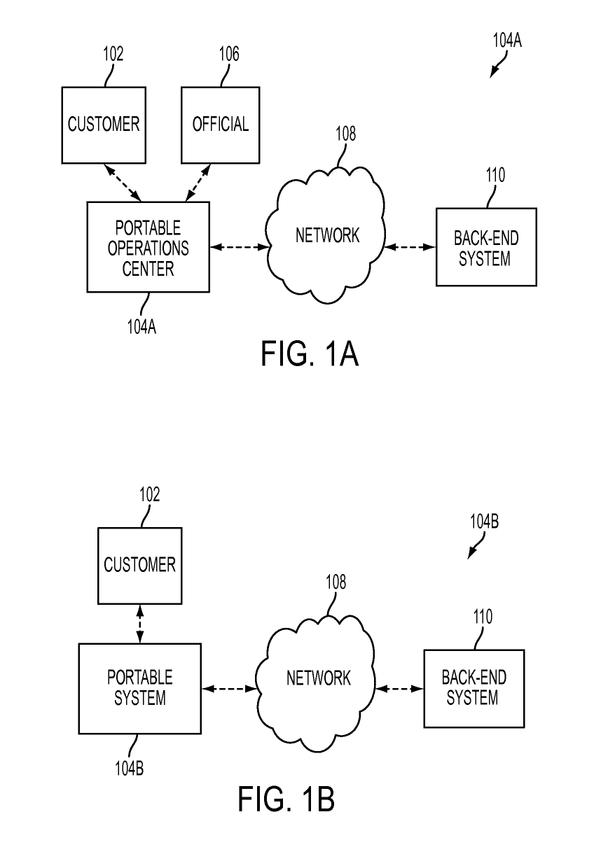

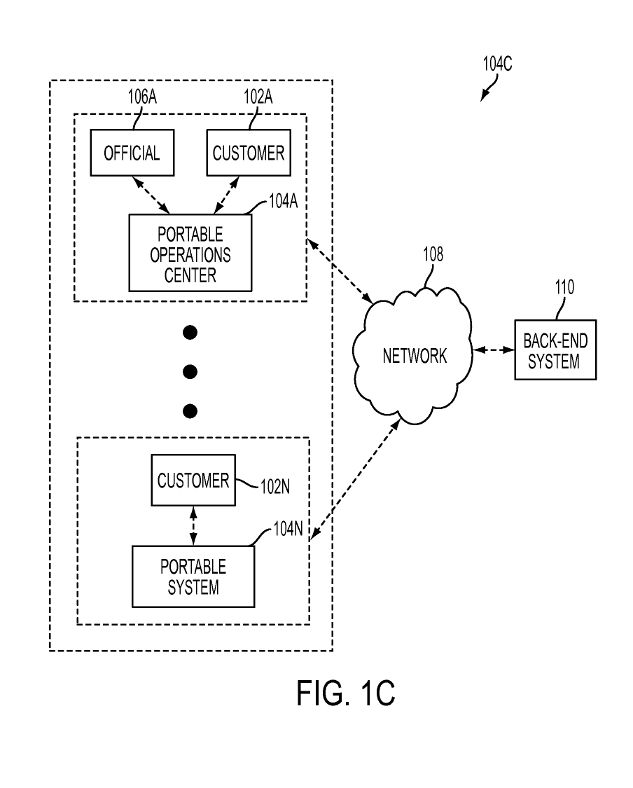

FIG. 1A illustrates an exemplary environment 100A where various embodiments of the present disclosure may be practiced. In particular, the environment 100A may include a customer 102, a portable system 104A or (a portable business center 104A), an official 106, a network 108, and one or more back-end systems. The customer 102 and the official 106 may interact with the portable system 104A for various purposes. The portable system 104A is also a scalable system. Further, the portable system 104A is an assisted portable system 104A, as the customer 102 may access the portable system 104a with assistance from the official 106. However, although the environment 100A shown in FIG. 1A shows only one customer 102 and one official 106, there can be any number of officials or customers. The portable system 104A may connect to the network 108 for sending and/or receiving data. The portable system 104A and the network 108 may communicate using conventional network protocols.

For the sake of simplicity, the present disclosure will be described using banking as one of the application areas. However, a person ordinary skill in the art would understand that the disclosed embodiments may be implemented for various other business domains, including but not limited to, telecom, post-offices, educational services, insurance, and so forth.

Further, the portable system 104A may be connected to various back-end systems or offices 110 via the network 108. Examples of the back-end system 110 may include, but are not limited to, an insurance company, an educational service provider, a remote bank branch, processing centers for requesting stationary, a third party validation system, or the like. Moreover, the portable system 104A is capable of sending or receiving information electronically via the network 108. This reduces the need to courier documents, such as application forms, proof of identity or address, or a photograph, to the banking organization or the back-end system 110. Thus, the use of hard copies of various documents can be reduced, thus reducing processing delays caused by the need to obtain hard copies In addition to this, the portable system 104A is configured to process the information.

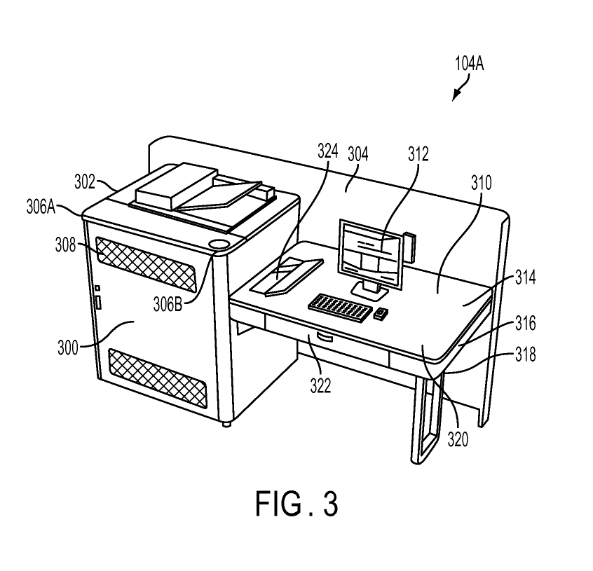

In one embodiment, the environment 100A may include two or more portable systems 104A that can be placed in any area, based on the needs of customer(s) 102. According to this embodiment, the two or more portable systems 104A may be connected to each other via network 108. Further, the portable system 104A may include an MFD (described in FIG. 3), a user interface, and a network interface. The portable system 104A may connect to the network 108 through the network interface.

The customer 102 may use the portable system 104A (when implemented in a bank), for various purposes, but not limited to, opening a new bank account, applying for a loan, changing personal information, and similar services. Hereinafter, the portable system 104A may be referred to as a portable banking system.

The customer 102 may be required to provide one or more credentials, such as a username and password, to access the portable banking system 104A. After the successful login and authentication, various options, such as creating a new account, and paying bills, are displayed to customer 102. Based on the option chosen, customer 102 may be required to fill out an application form may be displayed on the user interface of the portable banking system 104A and then the filled application form may be sent over the network 108 for further processing. For example, if the customer 102 chooses an option “apply for loan,” the customer will need to fill out the corresponding loan application form. In another example, if the customer 102 opts for “view summary statement” an account summary statement is displayed. In one embodiment, the official 106 may fill out an application form on behalf of the customer 102. As described above, the portable banking system 104A may act as a bank branch within itself to perform all types of bank operations. Typically, the portable banking system 104A can be placed and installed in any area including rural or urban areas. Further, the portable system 104 is scalable.

As shown in FIG. 1A, the official 106 may include a bank official, for example, a branch manager. The official 106 may use the portable banking system 104A to perform one or more functions, but not limited to, managing customer accounts, managing branch reports and managing requests for opening new accounts. In one embodiment of the disclosure, the official 106 may upload and download one or more documents. The documents may relate to the customer 102 or may correspond to branch reports, and the like. Alternatively, the portable system 104A may be operated without an official 106 as shown in FIG. 1B.

In one embodiment, the official 106 may assist the customer 102 in various bank related activities including filling an application form, verifying the information of customer 102, and so forth. In another embodiment, the official 106 may perform one or more functions, for example, filling a tax saving form, filling a DA1 nomination form, completing a signature change form, and the like, on the behalf of customer 102.

The network 108 may be used to connect the portable banking system 104A to a headquarter systems, support systems or peer systems. The support systems or the peer systems may form a part of the systems 110, including a stationery office, a processing center for verifying the one or more filled in forms and documents, an office for data entry, an office for courier or shipping of documents, third party validation systems or a center for any other manual work. According to an embodiment of the present disclosure, the network 108 may be wired or wireless. The network 108 may include all types of conventional wired or wireless network. Various examples of such networks may include, but not limited to, Local Area Network (LAN), Wide Area Network (WAN), a Metropolitan Area Network (MAN), Wireless LAN, and so forth. Additionally, the network 108 can be a local, regional, or a global communication network such as an enterprise telecommunication network, the Internet, a global mobile communication network, or any combination of similar systems. For example, network 108 may be an interconnection between an enterprise network, the internet, and a cellular network. The network 108 may be a combination of an enterprise network (or the Internet) and a cellular network, in which case, suitable systems and methods are employed to seamlessly communicate between the two networks. For instance, a mobile switching gateway may communicate with a computer network gateway to pass data between the two networks. Similarly, if the network 108 includes two or more networks employing differing protocols, suitable interfaces may be introduced to allow communication between these disparate networks.

If the network 108 connecting the portable banking system 104A is wireless, the portable banking system 104A may include a cellular interface integrated on it providing cellular capability. The cellular interface further facilitates communication with network 108.

The portable system 104A may be installed at a location where it is convenient or otherwise beneficial for the customer 102 to perform one or more processes in the presence of an authorized official(s) 106. Hereinafter, the portable system 104A may be referred as an assisted portable system 104A. For example, the portable system 104A may be installed at a location where it is advantageous for a business process unit to have the customer(s) 102 perform complex processes that may require assistance in person. In an exemplary scenario, the portable system 104A may be set up where a target user group, i.e., the customer(s) 102, prefers or needs human assistance for interacting with the portable system 104A to accomplish one or more operations.

In an embodiment, the portable operations center 104A may be configured to use with supplies relevant to business performed at the center 104A. The portable operations center 104A can include the electronic multi-function device (MFD) capable of performing at least one of scanning, photocopying, facsimile transmission and electronic storage. The portable operations center 104A can further include a user interface enabling interaction with and operation of the MFD. The portable operations center 104A can also include a business operations structure that is contiguous with the MFD and the user interface. The business operations structure is configured to enable portability of the center. The business operations structure can include a surface to facilitate completion of the paperwork, a partition to provide privacy during access to the center, and a storage unit configured to house the supplies.

The above disclosures relating to installations of the portable system 104A are provided for exemplary purposes and are not intended as limiting. For example, some embodiments of the portable system 104A are configured to be installed or otherwise placed in a certain location on a permanent or semi-permanent basis, while other embodiments are configured to be placed in certain locations more temporarily. In fact, the anticipated or intended permanence of installations is a design factor for some embodiments of the portable system 104A shown in FIG. 1A, as well as the system 104B, shown in FIG. 1B, which is discussed below.

FIG. 1B illustrates another exemplary environment 100B where various embodiments of the present disclosure may be practiced. The environment 100B may include a portable system 104B, one or more customers 102, the network 108, and the back-end system 110. As shown, the customer 102 can interact with the portable system 104B without assistance from any official 106 associated with a business process unit or back-end system 110. The portable system 104B is a self-service unit and no human assistance is required for interacting with the portable system 104B. Hereinafter, the portable system 104B may be referred as a self-service portable system 104B. The portable system 104B is a compact, physical space saving unit that can support one or more business operations. The portable system 104B may be installed in areas where the target group of users is capable of interacting with the portable system 104B to accomplish the activities or tasks of the business process unit without any assistance from the official 106. In an embodiment, the portable system architecture 104C may be installed or set up in an area, for example, in an urban area where population or target user group is sophisticated and may not require or may not prefer human assistance to access, and interact with the portable system 104B.

In an embodiment, the portable system 104B may be configured to use with supplies relevant to business performed at the system 104B. The portable system 104B can include the electronic multi-function device (MFD) capable of performing at least one of scanning, photocopying, facsimile transmission and electronic storage. The portable system 104B can further include a user interface enabling interaction with and operation of the MFD.

FIG. 1C illustrates yet another exemplary environment 100C where various embodiments of the present disclosure may be practiced. As shown (or a portable business center 104A), the environment 100C may include a combination of the portable system 104A and 104B. Though FIG. 1C shows only one portable system 104A and one portable system 104B, a person skilled in the art will appreciate that the environment 100C may include any number of portable systems 104A and 104B. As shown, a branch of a business process unit, such as a bank, may be set up by installing an assisted portable system 104A and a self-service portable system 104B. Hereinafter, the environment 100C may be referred as a multi-unit system that can be created with desired configurations to support growth of the business process unit or to scale up the business process unit. The multi-unit system may be set up when a business process unit requires a combination of functions as described in FIGS. 1A and 1B. The multi-unit system may be set up when a business process unit needs to expand its branch with multiple instances of the self-service portable system 104B and the assisted portable system 104A.

In an embodiment, multiple screens may be attached to each of the portable systems 104A and 104B. Therefore, in this embodiment, multiple users can access and use the portable systems 104A and 104B simultaneously for one or more activities. If the business process unit is a bank, the activities may include opening an account, closing an account, updating contact details, requesting a check book, and so forth.

Further, the business operations structure of the portable business center 104A and portable system 104B may be configured such that, the surface defines a number of curved edges to enhance portability. Further, the storage unit may be configured to house the supplies that include at least one of forms, manuals, records, and promotional materials. The business operations structure may further include a casing around at least a portion of the multi-function device that defines perforations to facilitate ventilation, a cable management unit to enable connection of the multi-function device with a power source, and a print-out interface providing access to printed materials.

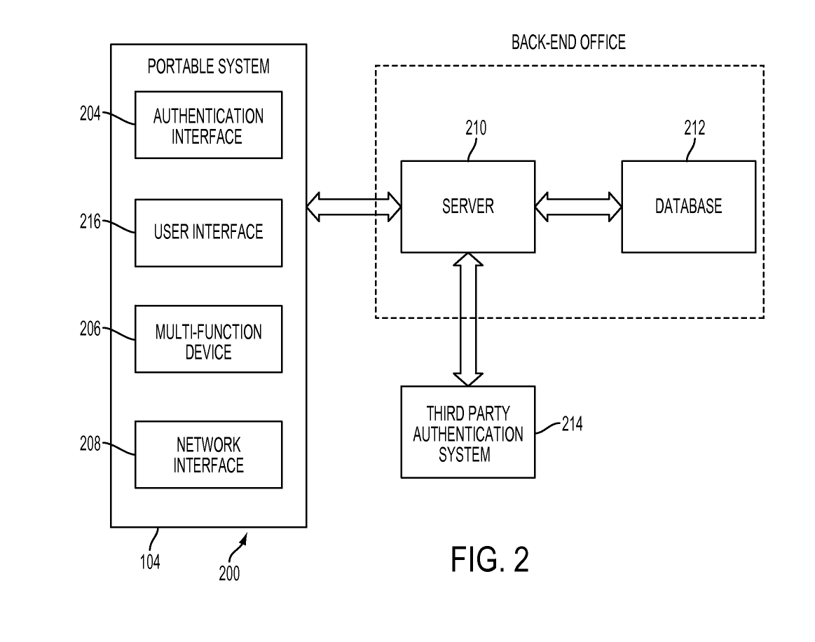

FIG. 2 shows various components and system elements 200 for implementing embodiments of the present disclosure. FIG. 2 illustrates the portable system 104 (collectively referring to portable system 104A and 104B), a server 210, a database 212, and a third party authentication system 214. Further, the portable system 104 may include an authentication interface 204, a user interface 216, a multi-function device 206, and a network interface 208. As depicted in FIG. 2, the portable system 104 may communicate with the server 210 using conventional network protocols and the server 210 may further communicate with the database 212 for storage. Moreover, the server 210 may communicate with the third party authentication system 214. Additionally, the server 210 and the database 212 collectively, may form a part of a back-office, a remote branch, for example. Each of these system components will be described in greater detail below.

In one embodiment of the present disclosure, the portable system 104 is integrated with bank services. According to this embodiment, the portable system 104 may be embodied in the form of a portable banking system facilitating all types of bank services to users (or the customer(s) 102). In another exemplary embodiment, the portable system 104 may be integrated with telecom services. For such scenarios, the portable system 104 in the form of a portable telecom system may provide various telecom services to users. Additionally, the portable system 104 may be integrated with postal services. In such embodiments, the portable system 104 may be referred to as a portal post-office system providing postal services to users. In additional embodiments, the portable system 104 may be integrated with various other types of services according to their requirements.

For the sake of explaining the embodiment of FIG. 2, the example of portable banking system is used. It should be clear to one skilled in the art that the disclosure should not be limited to the specific application described in the various embodiments.

The portable banking system 104 is capable of performing all of the functions that are typically conducted at a bank branch, thereby, allowing customer(s) 102 to perform any bank related activity. As mentioned above, the portable banking system 104 includes an authentication interface 204, a user interface 216, a multi-function device 206, and a network interface 208.

In one embodiment, the portable banking system 104 may further include an input interface, an output interface, an Automated Teller Machine (ATM), a processing module, an extraction module, a categorization module, a cellular interface, a power source, a physical case, and an internal storage device. According to an aspect of the disclosure, various components of the portable banking system 104, such as an ATM, a cellular interface, an internal storage device, and a physical case can be separated and can be re-attached to the portable banking system 104 at a later time. The components as mentioned above may be in the form of hardware or software modules. In an embodiment of the present disclosure, any other components including software and/or hardware components that are required for operating the portable banking system can be easily integrated with it.

Additionally, the components/modules of the portable banking system 104 are connected internally via a communication bus that is known in the art and is not described in detail herein. The aforesaid components perform their respective functions and further interact with each other, thereby, enabling the portable banking system 104 to function appropriately.

In one aspect of the disclosure, the portable banking system 104 may have multiple user interfaces so that multiple customers 102 can access the portable banking system 104 simultaneously. As an example, the exemplary embodiment may include multiple terminals with an application running the terminals and interacting with the portable system 104. Each terminal is used by a customer 102 and thus can serve multiple customers simultaneously.

The authentication interface 204 as described above performs authentication for a customer 102. In particular, the authentication interface 204 authenticates the customer 102 based on the credentials input by the customer 102, for example, a user name and password. In other embodiments, the authentication interface 204 authenticates the customer 102 based on the fingerprint or thumbprint as the input.

The multi-function device 206 may represents a single unit performing one or more functionalities. As mentioned herein, the multi-function device 206 is generally utilized for printing, scanning, copying, faxing data and/or other known imaging functions. Data may be in the form of one or more documents. Additionally, the multi-device 206 may perform image-processing functions when required. The multi-function device 206 may be further utilized for enhancing the quality of scanned information by skewing the information appropriately, varying the contrast, removing noise and so forth. It will be understood that the multi-function device 206 may perform one, few, or all of the described operations without departing from the scope of the disclosure.

Moreover, the multi-function device 206 is configured intelligently to identify the request type received from the customer 102. Based on the request type, the multi-function device 206 connects the portable system 104 to the desired back-office. For example, if the customer 102 requests uploading or downloading documents, then the multi-function device 206 may connect the portable system 104 to the remote bank branch. If the customer 102 puts a request for stationary, then the portable system 104 is connected to the stationary office. In an embodiment, the multi-function device 206 may include an intelligent processing module to perform the above-mentioned processes.

Additionally, the multi-function device 206 may include a database for storing information.

As described above, the multi-function device 206 may be replaced with one or more units having the functionalities of printing, scanning, copying, and faxing. Alternatively, the multi-function device 206 may be replaced with a separate printer, scanner, and copier. For various other embodiments, the multi-function device 206 may be a standalone printer or facsimile machine. The multi-function device 206 performs various functions as known in the art. In one exemplary embodiment, the multi-function device 206 can perform financial transactions based upon one or more checks, including depositing or debiting money, for example. The multi-function device 206 can also scan the content of checks. In addition, the multi-function device 206 can print checks based on the request by the user 102.

The User Interface (UI) 216 enables the customer 102 to perform one or more branch related activities. In particular, the user interface 216 can be used for receiving an input and displaying an output in the desired format. In one embodiment, the UI 216 displays one or more instructions on the display or relays, them over an audio system. Some instructions may require user inputs as well. In such instances, UI 216 may impart interactive capabilities to the display device, allowing users to provide information through a keypad, a touchpad, or simple operation buttons on the portable banking system. Further, the UI 216 of the portable banking system 104 may be configured to be interactive and elaborative enough so that the customer 102 can easily perform the desired activity. Accordingly, the customer 102 can move from one screen to other with ease. In addition, the UI 216 can be searchable and further allows the customer 102 to locate the required information.

In an embodiment, the UI 216 may include an intuitive UI. Alternatively, the UI 216 may be configured to recognize a physical gesture. For other embodiments, the UI 216 may include multiple modes of communication, for example, it may be a simple display, an interactive touch screen display, an audio system, a combination of a display and audio system. The UI 216 may further receive the processed information from the processing module for display.

The network interface 208 may be configured to connect the portable banking system 104 to the network 108, and the network 108 may further connect the portable banking system to different back-end offices (or back-end systems 110), such as a remote bank branch, for example. The network interface 208 further facilitates smooth communication between the portable banking system 104 and the remote bank branch. In an embodiment, the network interface 208 may be integrated with the multi-function device 206.

The input interface as described above receives an input provided by the customer 102. In one aspect of the present disclosure, the input may be provided using input devices, such as a keyboard, mouse, display, user interface, touch pad, and the like. Moreover, the output interface provides the output to the customer 102 in various forms including document and display. Various examples of output devices may include, but not limited to, printer, scanner, display, and so forth. In another example, the output device may include the multi-function device 206.

The ATM as included in the portable banking system 104 has a conventional structure/functionalities and is not described herein in detail. The ATM typically allows the customer 102 to conduct various monetary transactions. Further, the processing module processes/computes the information. Furthermore, the compression/decompression module may compress or decompress the information using one or more pre-defined algorithms as known in the art and thus, is not be described in detail here.

The extraction module extracts one or more fields, such as first name, last name, age, phone number, and address, from the information. Moreover, the categorization module categorizes the information based on one or more parameters, but not limited to, account type, customer type, and so forth.

The cellular interface as mentioned above provides cellular capability to the portable banking system 104. Usually, the cellular interface connects the portable banking system 104 to the network 108 via wireless communication channel even when the portable banking system 104 is being moved from one place to other.

In one embodiment, the cellular interface may allow the portable banking system 104 to receive information from another portable banking system and send information to the other portable banking system. To this end, the cellular interface includes a cellular port and a cellular card. Further, the cellular card may employ hardware, software and firmware imparting cellular functionality to the portable banking system 104. Additionally, cellular card can employ a cellular modem via which the portable banking system 104 can be accessed. Such cellular components are known to those skilled in the art and thus, are not be described in detail here. It is to be appreciated and understood that cellular components need not reside inside the portable banking system 104. Some of the components that impart cellular functionality can be configured externally to the portable banking system 104. The cellular interface may also include a cellular antenna (not shown) to detect cellular signals and transmit information when required.

The cellular interface may include any known cellular technology, such as global system of mobile communication (GSM), code division multiple access (CDMA), wideband CDMA (WCDMA), Time Division Synchronous CDMA (TD-SCDMA), and so on. It will be understood that any known or future developed telecommunication technology may be utilized to provide cellular connectivity. For GSM technology, the cellular card may be a Subscriber Identity module (SIM card). It will be understood that because the portable banking system 104 is connected to a cellular interface it may be moved anywhere in the world. As mentioned above, the portable banking system 104 includes a power source such as a battery for providing power to the power banking system 104. The power source may include a car battery or a fueled power generator.

Additionally, the physical case as mentioned above represents a box or casing in which the portable banking system 104 can be placed. An internal storage device stores information locally in the portable banking system 104. Thus, maintaining information locally on the portable banking system 104 acts as a backup in case of data losses at server end. The information may relate to a customer (such as the customer 102), a bank official (such as the official 106), bank related activity, bank services, customers' profiles, customer preferences, customer history, and so forth.

According to an embodiment of the present disclosure, the portable banking system 104 may include slots for a platen. A platen is a flat plate that can be pressed against a medium such as paper for printing or imaging applications.

Moreover, the portable banking system 104 may include a back-office interface. The back-office interface connects the portable banking system 104 to various bank-end offices such as a remote bank branch, an office for requesting the stationary, or the like. According to this embodiment, the portable banking system 104 can access servers, database, and systems present in the back-end offices. The back-offices may perform any manual work if needed, such as data entry, courier, shipping and so forth.

For one embodiment of the disclosure, any type of user including the customer 102 or the official 106 such as a bank official may use the portable banking system. Further, customers may be in the form of individuals or business. The official(s) 106 may check the logs twice a day, for example, at the beginning of a day and at the end of the day via the portable banking system. Customers may use the portable banking system for multiple purposes such as savings, loans, investments, taxes, bill payments, checks, and other similar services.

As illustrated in FIG. 2, the server 210 (such as a bank server) receives information from the portable banking system 104 and performs various functions including compression, de-compression, extraction, categorization, and so forth. These functions are discussed above in detail. The server 210 further sends the required information to the portable banking system 104. Similarly, the server 210 receives information from the portable banking system 104. Along with this, the server 210 interacts with third party authentication system 214 for validations. The database 212 (such as a bank database) stores information related to customers, services, and the like. In one embodiment, functionalities of the database 212 may be integrated with the server 210 forming a single unit.

Additionally, the third party authentication system 214 verifies whether the information provided by the customer 102 is accurate. The third party authentication system 214 further verifies whether the information, for example, proof of identity and/or address as provided by the customer (such as 102) are accurate. Various examples of proof of identity may include, for example a PAN. Examples of various proof of address may include, but are not limited to, a Voter ID, a Ration card, a driver's license, a passport, and so forth. In one embodiment, the third party authentication system 214 as mentioned herein may check whether the PAN matches with the name of the customer and so on. Upon verifying the information, the third party authentication system 214 communicates the outcome to the server 210. Subsequently, bank official 106 or the server 210 can take the necessary action. In one embodiment, the server 210 may be connected to the third party authentication system 214 via an Application Program Interface (API).

The elements of the portable system 104 shown in FIG. 2 are merely provided for exemplary purposes. In fact, some embodiments do not include some or all of the disclosed elements, including the authentication interface 204, the user interface 216, the multi-function device 206 and network interface 208, and/or may include elements in addition to those shown in FIG. 2. For example, the portable system of some embodiments only includes certain elements consistent with anticipated or intended functions to be performed by or at the operations center.

FIG. 3 illustrates the portable business center 104A according to another embodiment of the disclosure. As discussed with reference to FIG. 1A, the environment 100A may include the portable business center 104A, the customer 102, the official 106, the network 108, and the back-end system 110. The portable business center 104A may include a multi-function device (MFD) 300 (similar to the MFD 206 of FIG. 2). The multi-function device 300 may include a surface 302 for keeping one or more stationery items. Further, the surface 302 may include one or more curved edges 306A-B for accommodating space constraints and portability. Though FIG. 3 shows only two curved edges 306A-B, the surface 302 of the MFD 300 may include additional curved edges. The environments 100A-100B may include multiple customers who can interact with the MFD 300 or the portable business center 104A.

The MFD 300 may include a customizable partition 304 for providing visual privacy to at least one of the official 106 and one or more customers 102. As explained in FIG. 1A-1C, the customer 102 or the official 106 may be completing various forms, and therefore, the customizable partition 304 may provide visual privacy to the customer 102 or the official 106. The MFD 300 may further include a perforated pattern 308 across at least three sides of the MFD 300 for ventilation. The perforated pattern 308 may provide ventilation to prevent over-heating of the MFD 300. Though not shown, the perforated pattern 308 may be present on a fourth side of the MFD 300. The MFD 300 may further include a cable management unit 310 for connecting the MFD 300 with a power source (not shown). The power source may provide electric power to the MFD 300 or the portable system 104A. The MFD 300 may further include one or more storage units 314, 316, and 318 for storing promotional material, a number of filled forms, a product manual, and one or more maintenance records. In one embodiment, the MFD 300 may include one or more storing units to store promotional material, a number of filled forms, a product manual, and one or more maintenance records. The MFD 300 may also include a collaboration surface 320 to allow the official 106 or the customer(s) 102 to fill-up the multiple forms or other documents by keeping the forms on the collaboration surface 320. The MFD 300 may further include one or more drawers 322 for storing the one or more stationary items.

As discussed in FIG. 2, the customer 102 can take out printouts of one or more documents from the portable business center 104A and portable system 104B. The MFD 300 may also include a printout interface 324 for providing a point of interaction for the customer(s) 102 in order to access one or more printouts. The printouts may be of an application form or other identification related documents.

The portable business center 104A may also include a user interface 312 coupled to the MFD 300 for allowing at least one of the official 106 and the customers 102 to interact with the MFD 300. The user interface 312 may include a screen, wherein the screen can be a touch sensitive screen. In an embodiment, the screen can be a monitor. The user interface 312 may further include a number of configurable authentication devices. In addition, the user interface 312 may include a number of authentication interfaces for authenticating the identity of the customer(s) 102 or the official(s) 106. The user interface 312 may be coupled to the MFD 300 for performing a number of functions. The functions may include sending a request to the one or more remotely located systems, completing one or more forms electronically for a predefined service, and sending or receiving electronic documents to and from the one or more remotely located systems. The remotely located systems may include headquarters systems, support systems, back end system, and peer systems.

The portable business center 104A may further include a network interface coupled to the MFD 300 and the user interface 312, the network interface may provide connectivity and communication between the portable business center 104A, and one or more remotely located systems including headquarters systems, support systems, back end system 110, and peer systems. Further, in an embodiment, the user interface 312 is not integrated with the MFD 300. The portable business center 104A may include a sitting area where the official 106 and/or the customer(s) 102 may sit and interact with the MFD 300 or the portable business center 104A. The MFD 300 may be encased in a casing made up of a material, such as, but not limited to steel. The material of the casing may be chosen based on one or more requirements, such as but not limited to, cost efficiency, durability, maintenance efficiency, image perception, and so forth.

In an embodiment, the MFD 300 may further include a cellular interface for providing cellular capability based on one or more parameters. The MFD 300 may also include one or more modules as has been described in FIG. 2 in detail.

In some embodiments, one or more elements or components of the MFD 300 may form part of a business operations structure (not shown). The business operations structure may be contiguous with the multi-function device 300 and the user interface. The business operations structure may be configured to enable portability of the center, the business operations structure include a surface (or collaboration surface 320) to facilitate completion of the paperwork, the partition 304 to provide privacy during access to the center, and a storage unit (314, 316, 318 and 322) configured to house the supplies such as forms, manuals, records, and promotional materials.

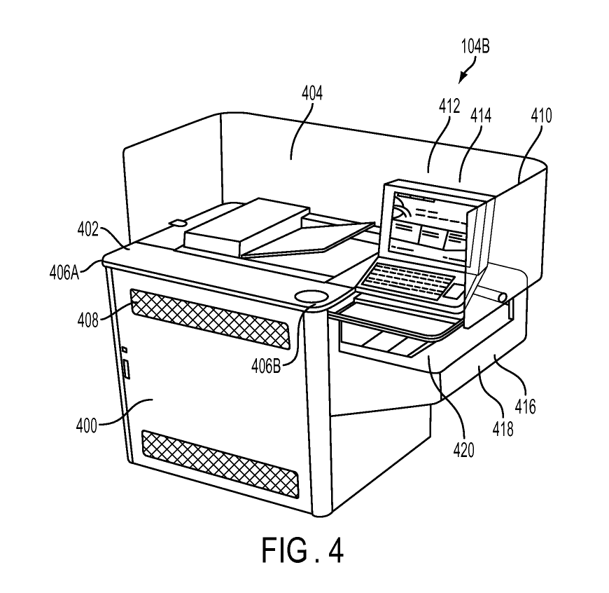

FIG. 4 illustrates another exemplary portable system 104B according to another embodiment of the present disclosure. The portable system 1048 may include a multi-function device (MFD) 400, a user interface 412, and a network interface (not shown). The portable system 104B is a compact and scalable system what may be implemented in rural or urban areas to perform one or more business operations associated with a business process unit such as, but not limited to, a bank, a postal company, and so forth. Typically, the portable system 104B may be implemented and installed in urban areas, where the population is sophisticated and can interact with the portable system 104B or the MFD 400 without any assistance from the official 106 or any other user.

The MFD 400 may include a surface 402 for keeping one or more stationery items. The surface 402 may have a number of curved edges 406A-406B for accommodating space constraints. The surface 402 for keeping one or more stationery items is compact and occupies less space. Further, the MFD 400 may include a customizable partition 404 for providing visual privacy to the official(s) 106 and customer(s) 102 while filling a number of forms, such as application forms, and branding. The MFD 400 may further include a perforated pattern 408 across at least three sides of the multi-function device for ventilation. Further, the size and shape of the pattern 408 may vary. The MFD 400 may also include a cable management unit 410 for connecting the MFD 400 with a power source. The power source may supply electric power to the MFD 400 (or the portable system 104B). The MFD 400 may further include one or more storage units 414, 416, and 418 for storing promotional material, a number of filled forms, a product manual, and one or more maintenance records. The MFD 400 may further include a printout interface 420 (as shown in FIG. 4) for providing a point of interaction to the customer(s) 102 for accessing one or more printouts. The MFD 400 may be encased in a casing made up of a material, such as, but not limited to steel. The material of the casing may be chosen based on one or more requirements such as, but not limited to, cost efficiency, durability, maintenance efficiency, image perception, and so forth.

The user interface 412 may be coupled to the MFD 400 and the network interface. Further, the user interface 412 may allow the customer(s) 102 to interact with the MFD 400. The user interface 412 may include a screen that is a touch sensitive. In an embodiment, the MFD 400 may be attached to multiple screens. Further, the screen may be a 15-inch monitor. In an embodiment, more than one customer 102 may interact with the MFD 400 simultaneously with multiple screens attached to the MFD 400. Further, the user interface 412 may include one or more authentication devices and/or authentication interfaces to authenticate the identity of the customers 102 or other users interacting with the MFD 400. The customer 102 may be asked to enter one or more login credentials such as, but not limited to, a name and account number, via the authentication interface to identify his/her identity.

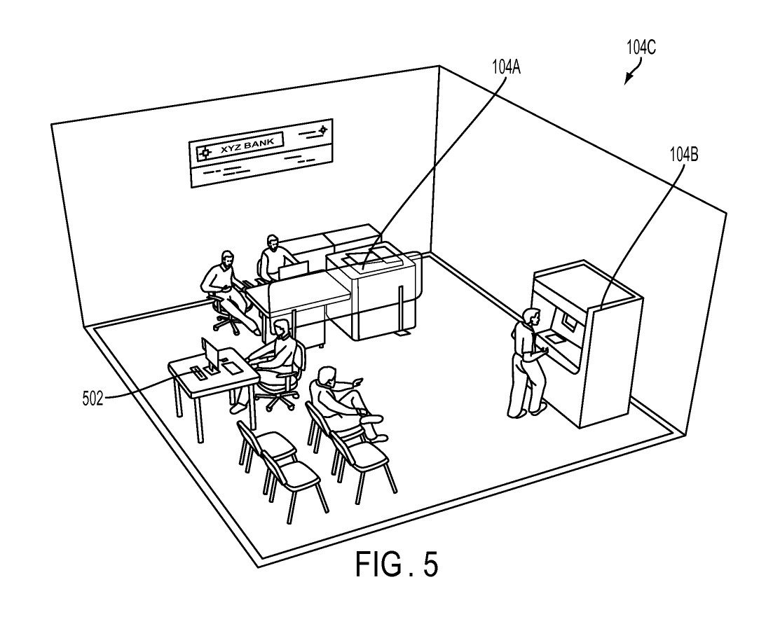

FIG. 5 illustrates an exemplary portable system architecture 104C according to another embodiment of the present disclosure. As discussed with reference to FIG. 3 and FIG. 4, the portable business center 104A and the portable system 104B may be set up in same branch of the business process unit as shown in FIG. 5. The portable system architecture 104C may be set up by using one or more of portable business center 104A and portable system 104B, and multiple user interfaces. The portable business center 104A and portable business system 104B may include more than one user interfaces like the display screen 502 (as shown). The customer 102 can interact with or operate the portable business center 104A (or the MFD 400) with assistance from the official 106. Further, the user i.e. the customer 102 and/or the official 106 may operate the portable system 104A by sitting in a sitting area of the portable system 104A. Similarly, one or other users such as another customer may interact with the portable system 104B.

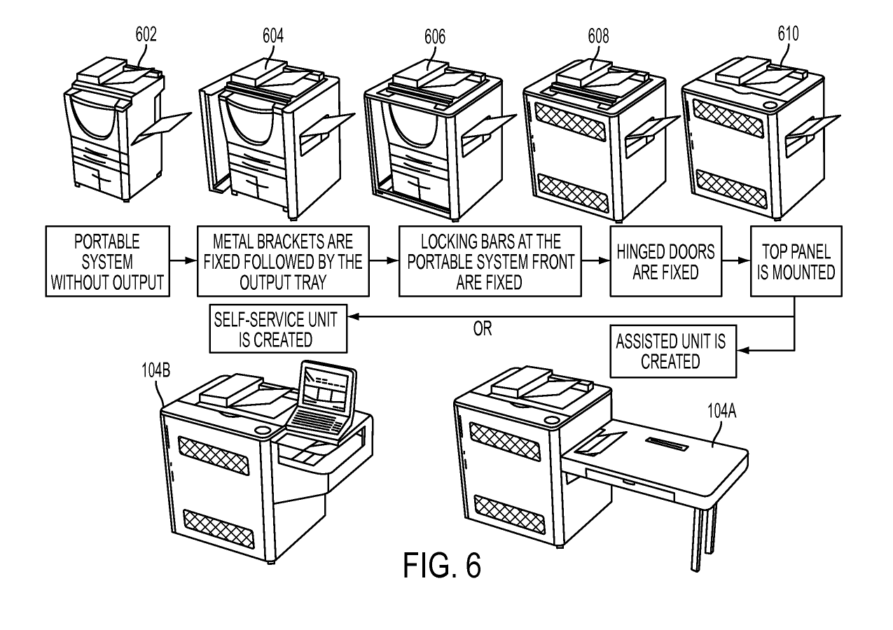

FIG. 6 illustrates various steps of configuring the portable business center 104A or the portable system 104B of FIGS. 1A-1B. A unit 602 shows a portable system without an output. One or more metal brackets may be fixed to the unit 602 and then an output tray may be fixed to form a unit 604. Then, one or more locking bars may be fixed at the portable system front to form a unit 606. Then, one or more hinged doors may be fixed to the unit 606 to form a unit 608. Thereafter, a top panel may be mounted to the unit 608 to form a unit 610. Then either a collaboration surface may be fixed to the unit 610 to form an assisted unit or a portable business center 104A, or a user interface may be fixed to the unit 610 to form the self service unit or the portable system 104B.

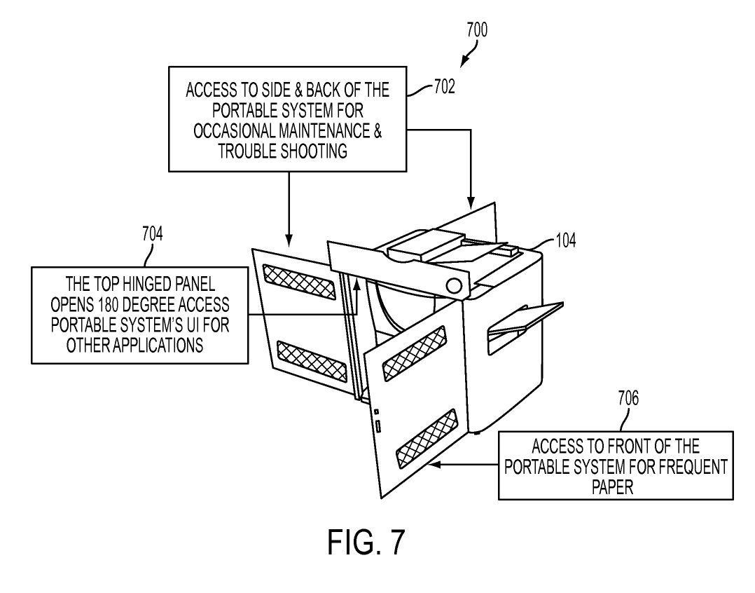

FIG. 7 illustrates one or more elements of the multi-function device 700. As discussed with reference to FIGS. 3 and 4, the casing of the MFD 300, 400 ensures that the MFD (300 or 400) is accessible for various services needs, frequent or occasional, such as, accessing paper trays to replenish papers, accessing other sides for maintenance or technical trouble shooting. As shown in 704, the front panel of the casing may allow access to the side and back of the portable system 104 for occassional maintenance and trouble shooting. Further, a top hinged panel provides 180 degree access to the user interfaces for other applications of the portable system 104 (shown as 704). A panel at bottom of the casing front of the porable system 104 may be accessed for frequent paper (706).

For the sake of further clarity, an exemplary method is described below. However, the exemplary method as describe should not limit the scope of the present disclosure. The method is described for a situation when a customer accesses the portable system 104, for example, as a portable banking system.

### At Portable System:

Initially, the customer 102 logs into the portable banking system. To login, the customer 102 needs to provide their credentials, for example, a user name and password. After this, the credential details are compressed and then transmitted to the server 210, such as the bank server. Then, a check is performed to verify whether the credentials as input by the customer 102 are accurate. In case the credentials input by the customer 102 are not accurate, the customer 102 is not allowed to proceed further. Otherwise, if the credentials are accepted, one or more options are displayed to the customer 102 via the UI 216. Various options may include, but are not limited to, creating a new account, applying for loans and so forth.

In one embodiment, the customer 102 may seek to open an account with a bank. Accordingly, the customer 102 can choose an option to create a new account. Various types of accounts may be offered by a banking organization, such as a current account, a savings account, a foreign currency account and a term deposit account. The customer 102 then chooses a desired account type based on their requirements. The customer 102 may have different types of bank accounts with a banking organization. In one embodiment, the bank related services may be prioritized by the bank organization based on their requirements. For example, opening a bank account may be prioritized in comparison to fund transfers and bill payments.

After choosing the appropriate option, an application form is displayed to the customer 102 including one or more fields such as first name, last name, age, date of birth, permanent address, current residential address, and the like. Accordingly, the customer 102 inputs the required information through the portable banking system. Also, the official 106 presented with the portable banking system may help the customer 102 to understand the application form and may further assist the customer 102 while completing the various fields in the application form. The customer 102 may be required to fill out various forms such as a signature change form, a DA1 nomination form, tax forms, tax avoidance forms and internet banking forms. In one embodiment, the official 106 may fill these application forms on the behalf of the customer 102 later.

On successful completion of the application form, a registration number is assigned to the customer 102. Then, the customer 102 is required to print the filled application form. This can be done using a print command. Thereafter, the customer 102 scans the filled application form. For this, the customer is required to place the document on the platen of the portable banking system and the document is scanned. During scanning, the portable banking system extracts one or more fields such as name, account type, and location, from the forms and saves it in the local database of the portable banking system. Before storing the extracted data fields, they are compressed. Then, the information present in the scanned document may be realigned and enhanced further for clarity purposes. Thereafter, the customer 102 needs to provide one or more supporting documents, for example, identity proof, address proof, and so forth, for scanning. At the time of scanning, the image of the document is also captured.

While scanning the supporting documents, it is verified whether the information filled by the customer 102 in the application form matches with the information provided in the supporting documents. In case of successful verification, the scanned application form and the associated documents are sent to the network 108. For example, it is checked whether the name provided by the customer 102 in the application form matches with the name mentioned on the identity proof. Then, the information in the form of electronic documents is transmitted from the portable banking system to the network 108. In particular, completed information such as name, age, address, phone number, and the like is sent to the network 108 and images or graphics are reproduced at server end. The information can be compressed before sending it.

If the verification check fails, the customer 102 is prompted again to provide the correct information.

Additionally, the data extracted while scanning the documents can be further used for categorizing the information. The categorization can be performed based on various parameters such as account type, customer type and so forth.

### At Back End Office:

At server 210, the scanned electronic documents received from the portable banking system are uncompressed and then stored in the database 212, for example, bank database. In a similar manner, information from the documents is extracted and further saved in the database 212. Also, a bank official in the remote branch may perform an additional check to assure the information provided in the filled application form matches with the supporting documents. Along with this, the bank official may crosscheck the information/content extraction entries against the electronic documents. Then, the server 210 sends the required information such as a PAN card to the third party authentication system 214 for validation. In case of successful validation, the bank server proceeds with next steps.

Subsequently, a confirmation is sent to the customer 102 for the account creation. Typically, a unique account number or the customer identification number is provided by the banking organization through the portable banking system. Also, an instant bank opening pack is sent to the customer 102. Thus, the overall processing time to create the new account is significantly reduced. Similarly, the customer 102 may use the portable banking system for other services as mentioned above.

In one embodiment, the official 106 may also use the portable banking system for other purposes. When the official 106 logs into the portable banking system, options such as branch reports and customer accounts may be displayed. An appropriate user interface may then be presented based upon the option selected by the official 106.

When a bank official wishes to create a new account with the banking organization, the official follows the process as outlined above. However, required modifications/variations to the above process can be made.

Various aspects of the disclosure as outlined above with respect to bank services/portable banking system are illustrative in nature. The disclosure can be implemented for various other types of services as discussed above in detail. Any modification/variation to the method and system above can be made without departing from the scope of the disclosure.

The present disclosure describes a portable system that may performs various operations. The portable system communicates over a network to facilitate various services to users. The portable system enables users to fill out information electronically, thereby reducing the usage of paper documents. Thus, the portable system optimizes the document-driven workflow. Further, not many personnel are required to operate the portable system, thus, reducing staffing requirements. Also, the user can access the portable system anytime. Furthermore, the portable system can be easily moved from one location to another. The portable system also consumes less power. In addition, the portable system provides smooth workflow even at low connectivity speeds.

Typically, remote areas lack infrastructure and sometimes it is difficult to set up a permanent facility like a branch or a center. Establishing a branch in such areas results in high operating cost and with a low revenue stream. To serve the needs of such areas, the present disclosure proposes a portable system that performs operations that are performed on daily basis. The portable system can be moved from one rural area to other areas based on the requirements of customers of that particular area. Furthermore, the portable system requires fewer officials to run the branch, and thus, minimum staffing is required. Moreover, the portable system requires minimum power consumption to run. Thus, the overall cost of setting up a portable system in such areas is reduced largely. Therefore, the portable system is efficient in terms of capital and operating costs. In addition to the above, the portable system enables users to perform one or more activities electronically, and thus, optimizes paper related work. More than that, the portable system has automated workflows and is integrated with different back-end offices including remote branches, third party validation systems and the like.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A portable operations center for use with supplies relevant to business performed at the center, comprising:
an electronic multi-function device (MFD) capable of performing at least one of scanning, photocopying, facsimile transmission and electronic storage;
a user interface enabling interaction with and operation of the multi-function device; and
a business operations structure that is contiguous with the multi-function device and the user interface and configured to enable portability of the center, the business operations structure including: a surface to facilitate completion of the paperwork; a partition to provide privacy during access to the center, and a storage unit configured to house the supplies.

2. The portable operations center according to claim 1, wherein the business operations structure is configured such that: the surface defines a plurality of curved edges to enhance portability; the storage unit is configured to house the supplies that include at least one of forms, manuals, records, and promotional materials; and the business operations structure further includes:
a casing around at least a portion of the multi-function device that defines perforations to facilitate ventilation, a cable management unit to enable connection of the multi-function device with a power source, and a print-out interface providing access to printed materials.

3. The portable center of claim 2, wherein the MFD further comprises one or more drawers for storing the one or more stationary items.

4. The portable center of claim 3, wherein the MFD further comprises a collaboration surface to allow an official and at least one customer to access the at least one form.

5. The portable center of claim 1, wherein the user interface comprises at least one of a screen and a plurality of configurable authentication devices, and wherein the screen is a touch sensitive screen.

6. The portable center of claim 1, wherein the user interface is coupled to the MFD and a network interface for performing a plurality of functions including:
sending a request to the one or more remotely located systems;
completing one or more forms electronically for a predefined service; and
sending or receiving electronic documents to and from the one or more remotely located systems.

7. The portable center of claim 6, wherein the user interface further comprises at least one authentication interface for authenticating an identity of at least one of the customer and an official.

8. The portable center of claim 7, further comprising a network interface coupled to the MFD and the user interface, the network interface providing connectivity and communication between the portable system and remotely located systems including at least one of a headquarters systems, a support systems, a back end system, and peer systems.

9. The portable center of claim 1, wherein the user interface is integrated with the MFD.

10. The portable center of claim 1, wherein the user interface is not integrated with the MFD.

11. The portable center of claim 1, further comprising a sitting area where at least one of an official and a plurality of customers can interact with the MFD.

12. The portable center of claim 1, wherein the power source provides power to the portable system.

13. The portable center of claim 1, wherein the MFD further comprises:
an extraction module configured to extract information from the plurality of filled forms;
a processing module configured to process the extracted information;
a categorization module configured to categorize information based on one or more parameters; and
a cellular interface configured to provide cellular capability to the portable system.

14. The portable center of claim 1, wherein the portable center is associated with a business process unit including at least one of a banking service provider, an insurance service provider, an educational service provider, and a postal service provider.

15. A portable system comprising:
a multi-function device (MFD) including:
a surface for keeping one or more stationery items, wherein the surface have a plurality of curved edges for providing movement affordance in tighter spaces;
a customizable partition for providing visual privacy to at least one of an official and a plurality of customers while filling a plurality of forms and branding;
a perforated pattern across at least three sides of the multi-function device for providing ventilation;
a cable management unit for connecting the MFD with a power source;
one or more storage units for storing at least one of promotional material, filled forms, product manual, and one or more maintenance records; and
a printout interface for providing a point of interaction to the plurality of customers for accessing one or more printouts;
a user interface coupled to the MFD for allowing at least one of an official and a plurality of customers to interact with the MFD, wherein the user interface comprises at least one of a screen and a plurality of configurable authentication devices, wherein the screen is a touch sensitive screen; and
a network interface coupled to the MFD and the user interface for providing connectivity and communication between the portable system and one or more remotely located systems including headquarters systems, support systems, back end system, and peer systems.

16. The portable system of claim 15, wherein the MFD further comprises one or more drawers for storing the one or more stationary items.

17. The portable system of claim 16, wherein the MFD further comprises a collaboration surface to allow at least one of the official and the plurality of customers to fill-up plurality of forms.

18. The portable system of claim 17, wherein the user interface is coupled to the MFD and the network interface for performing a plurality of functions including:
sending a request to the one or more remotely located systems;
completing one or more forms electronically, for a predefined service; and
sending or receiving electronic documents to and from the one or more remotely located systems.

19. The portable system of claim 18, wherein user interface is integrated with the MFD.

20. The portable system of claim 19, wherein the user interface is not integrated with the MFD.

21. The portable system of claim 20 further comprising a sitting area where the at least one of the official and the plurality of customers interacts with the MFD.

22. The portable system of claim 21 further comprising a physical case to hold the MFD.

23. The portable system of claim 23, wherein the power source provides power to the portable system.

24. The portable system of claim 15 further comprising a cellular interface for providing cellular capability to the portable system.

25. The portable system of claim 15, wherein the portable business process system is scalable based on one or more parameters including, but not limited to, type of area, type of population, size of population, and so forth.
